(19) United States
(12) Patent Application Publication
(10) Pub. No.: US 2013/0009442 A1
(43) Pub. Date: Jan. 10, 2013

(54) PLASTIC ENCAPSULATED METAL SEAT PAN

(75) Inventor: Matthew Burnham, Allen Park, MI (US)

(73) Assignee: Nyloncraft Incorporated

(21) Appl. No.: 13/369,800

(22) Filed: Feb. 9, 2012

Related U.S. Application Data
(60) Provisional application No. 61/505,744, filed on Jul. 8, 2011.

(51) Int. Cl. B60N 2/68; B29C 51/00; B23K 20/12; B23K 26/20; B32B 37/12; B23K 20/10; B29C 45/14; B23P 11/00

(52) U.S. Cl. 297/452.18; 264/259; 29/428; 219/121.64; 156/60; 228/110.1; 228/112.1

(57) ABSTRACT

Seat pan assemblies and methods of making the same are disclosed. In one embodiment, a plastic seat pan is disclosed which encapsulates a metal front lift rod and a portion of a metal mesh seat support. Other embodiments are also disclosed.

### CROSS-REFERENCE TO RELATED APPLICATIONS

This application claims the benefit of U.S. Provisional Patent Application No. 61/505,744, filed Jul. 8, 2011, the text and drawings of which are hereby incorporated by reference in their entireties.

### TECHNICAL FIELD OF THE DISCLOSED EMBODIMENTS

The present invention relates to a seat pan. The invention relates more particularly, but not exclusively, to a plastic encapsulated metal seat pan.

### BACKGROUND OF THE DISCLOSED EMBODIMENTS

It is known in the art of seating systems, such as vehicular seating systems, to provide a rigid supporting structure or frame for a seat. The rigid structure performs multiple functions, such as providing mounting locations for securing the seat to a substrate (such as a vehicle chassis), providing the rigidity required for safety of the occupant of the seat, providing a mounting location for auxiliary seat components, such as electric motors and the like, and providing a framework for application of seating materials, such as cushioning and cover materials. In order to accomplish these functions, the seat supporting structure is typically fabricated from metal, such as steel or aluminum.

Particularly in the area of vehicular seating systems, the above functions of the seat supporting structure may be at odds with other design goals of the vehicle, such as the reduction of the weight of the vehicle to facilitate vehicle performance and fuel economy. Improvements have been made over the years, such as by designing support structures that use fewer and/or smaller metal pieces, thinner metal pieces, and even metal pieces replaced by exotic and expensive materials such as carbon fiber.

Even still, improvements are needed to further reduce the weight of seating systems, such as vehicular seating systems, while at the same time reducing the cost of such systems. The present invention is directed toward meeting this need.

### SUMMARY OF THE DISCLOSED EMBODIMENTS

In one embodiment, a plastic seat pan is disclosed which encapsulates a metal front lift rod and a portion of a metal mesh seat support.

In other embodiments, a plastic seat pan comprises an upper seat pan and a lower seat pan which encircle and/or encapsulate at least one seat pan support member. The seat pan support member may be a lift rod that is preferably made of metal but could also be made of carbon fiber or a hybrid metal/plastic. The seat pan support may also be a spring that supports the seat cushion. The spring may be made of metal, carbon fiber, textile, or a plastic resin mesh.

In one embodiment, a seat for a motor vehicle comprises a scat back, a seat pan coupled to the seat back, and the seat pan having upper and lower seat pan members that are configured and arranged to be joined together and encapsulate at least a portion of the seat pan support member positioned between the two.

In one embodiment, a motor vehicle seat comprises an upper seat pan member, a lower seat pan member, and a first seat pan support member encapsulated by the upper and lower seat pan members.

In another embodiment, a seat assembly comprises an upper seat pan member, a lower seat pan member, a first seat pan support member, and a second seat pan support member; wherein the upper and lower seat pan members are configured and arranged to confine at least portions of the first and second seat pan support members between the upper and lower seat pan members.

In one embodiment, a method of assembling a seat pan comprises positioning a first seat pan support member between an upper seat pan member and a lower seat pan member and joining the upper seat pan member to the lower seat pan member so as to encapsulate the first seat pan support member and assemble the seat pan.

In another embodiment, a method of forming a seat pan comprises positioning at least a portion of at least one seat pan support member in a mold and molding a plastic material around the seat pan support member to encapsulate at least a portion of the seat pan support member within the plastic material so as to form a seat pan.

Other embodiments are also disclosed.

### BRIEF DESCRIPTION OF THE DRAWINGS

The disclosed embodiments will be further described, by way of example only, with reference to the accompanying drawings, in which:

FIG. 1 is a side plan view of a seat of one disclosed embodiment.

FIG. 2 is a perspective view of a lower seat pan member of one disclosed embodiment.

FIG. 3 is a top plan view of a lower seat pan member of one disclosed embodiment.

FIG. 4 is a perspective view of an upper seat pan member of one disclosed embodiment.

FIG. 5 is a top plan view of an upper seat pan member of one disclosed embodiment.

FIG. 6 is an exploded view of a seat pan assembly of one disclosed embodiment.

FIG. 7 is a perspective view of a seat pan assembly of one disclosed embodiment.

FIG. 8 is a cross-sectional view of a seat pan assembly of one disclosed embodiment.

FIG. 9 is a perspective view of a seat pan assembly of one disclosed embodiment.

FIG. 10 is a perspective view of a seat pan assembly of one disclosed embodiment.

FIG. 11 is a perspective view of a partially assembled seat pan assembly of one disclosed embodiment.

FIG. 12 is a perspective view of an assembled seat pan assembly of one disclosed embodiment.

### DETAILED DESCRIPTION OF THE VARIOUS EMBODIMENTS

For the purposes of promoting an understanding of the principles of the invention, reference will now be made to the embodiment illustrated in the drawings, and specific language will be used to describe that embodiment. It will nevertheless be understood that no limitation of the scope of the invention is intended. Alterations and modifications in the illustrated device, and further applications of the principles of the invention as illustrated therein, as would normally occur to one skilled in the art to which the invention relates are contemplated, are desired to be protected. In particular, although the invention is discussed in terms of a vehicular seat pan, it is contemplated that the invention can be used with other seating types. Such alternative embodiments require certain adaptations to the embodiments discussed herein that would be obvious to those skilled in the art.

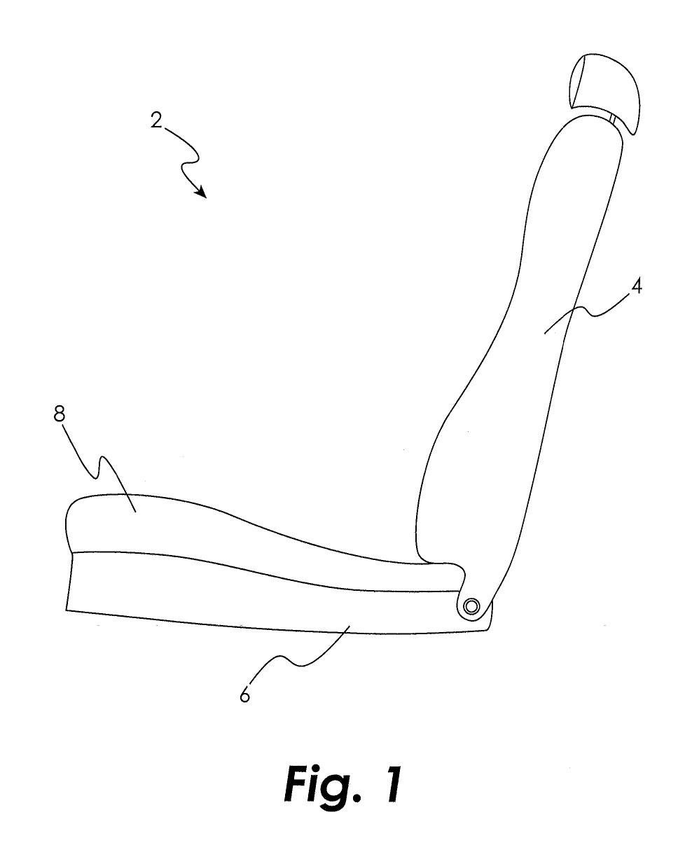

FIG. 1 illustrates a seat 2 having a seat back 4 and a seat pan 6 that supports an optional seat cushion 8. As one of ordinary skill in the art can appreciate, this type of seat may be used in a variety of applications including use as the driver and/or passenger seat(s) in a motor vehicle.

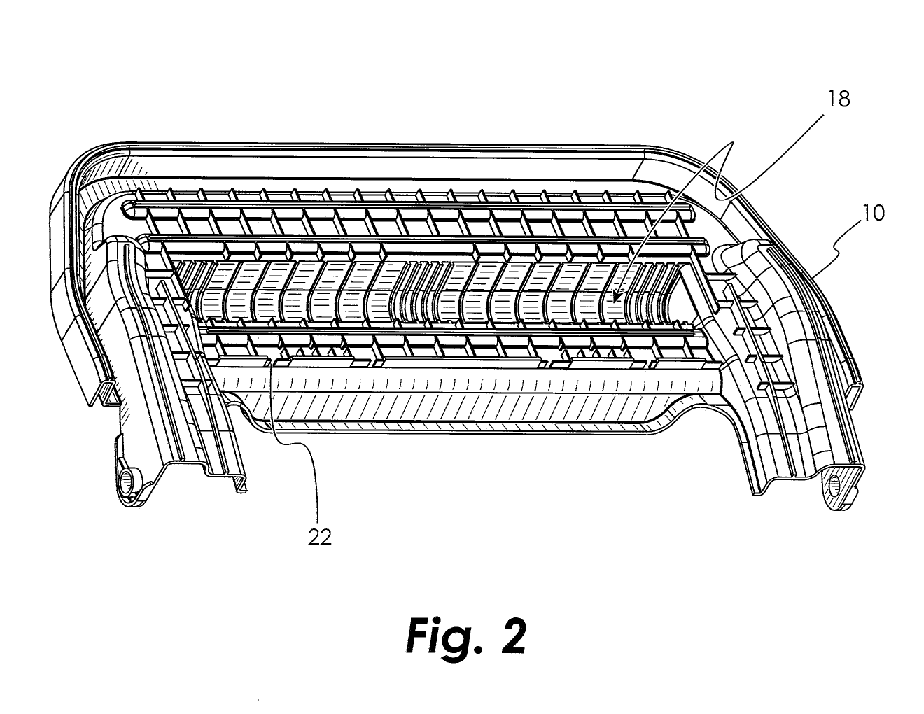

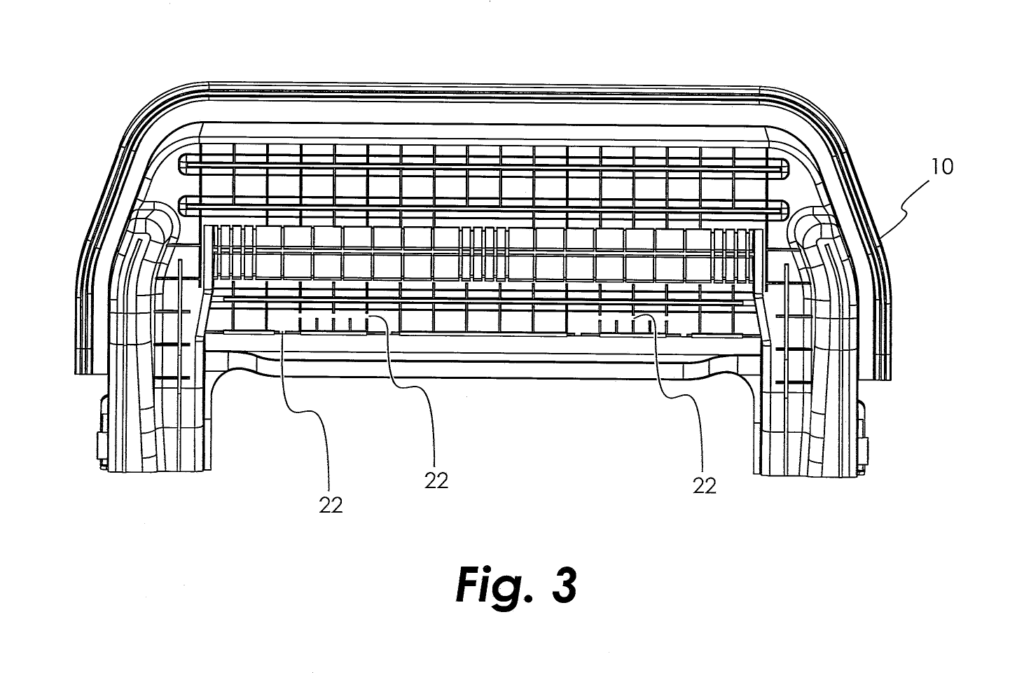

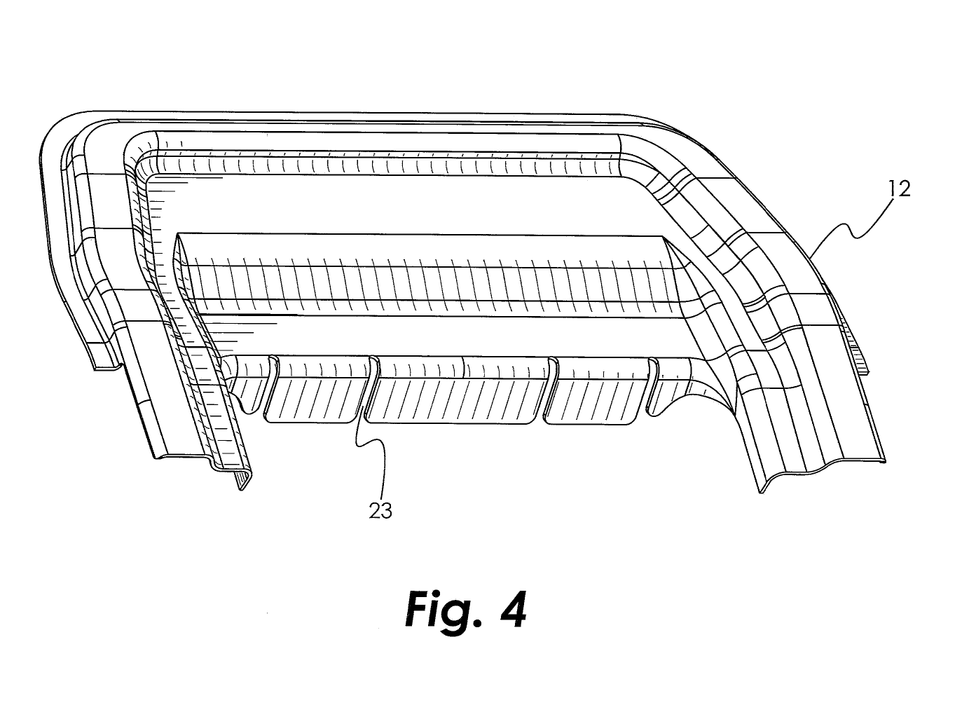

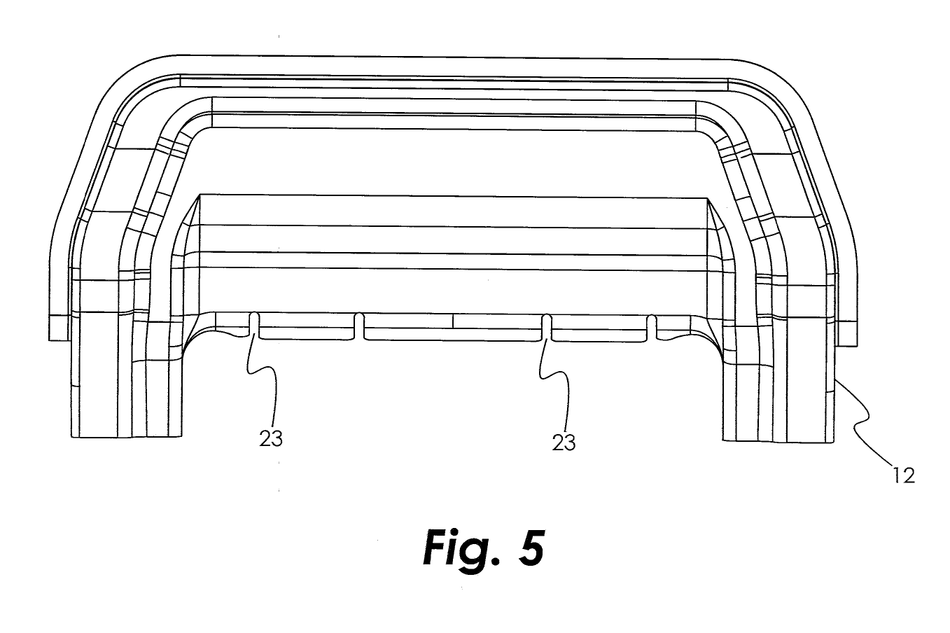

FIGS. 2-3 illustrate a lower seat pan member 10, and FIGS. 4-5 illustrate an upper seat pan member 12 according to one disclosed embodiment. As can be appreciated, the lower seat pan member 10 and upper seat pan member 12 may be reversed. The members 10, 12 may be formed from any suitable plastic material, such as polypropylenes, polyethylenes, polybutylenes or polyamides, to name just a few non-limiting examples. In some embodiments, the members 10 and 12 are comprised of the same or similar material(s), and in other embodiments the members 10 and 12 are comprised of different materials. For example, the upper seat pan member 12 may be comprised of a polypropylene and the lower seat pan member 10 may be comprised of a polyethylene. In another example, the upper seat pan member 12 may be comprised of a plastic material and the lower seat pan member 10 may be comprised of a plastic material and metal. The members 10, 12 may be formed by any suitable process, such as by injection molding, thermoforming, injection compression molding, or blow molding, to name just a few non-limiting examples. Generally, the lower seat pan member 10 includes much of the structural geometry that provides the required rigidity to the finished product to meet safety design standards as well as the traps or ribs required for joining the two members, while the upper seat pan member 12 contains corresponding geometry that generally follows and/or conforms to the contour of the lower seat pan member 10 and is needed to encapsulate components between the two panels as discussed in greater detail herein below,

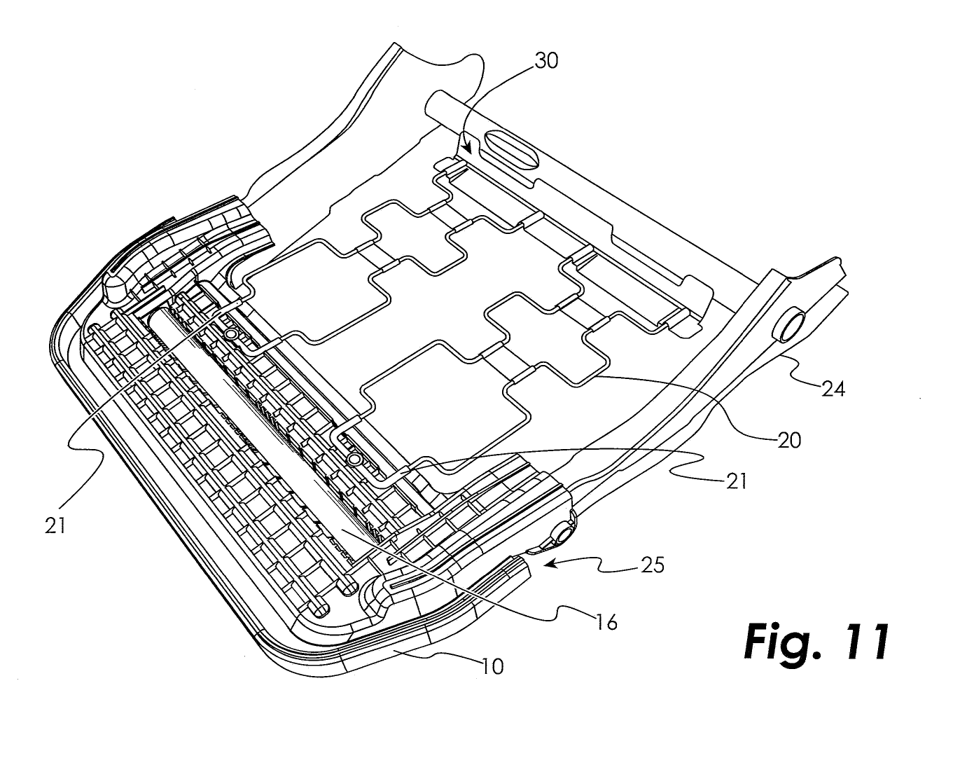

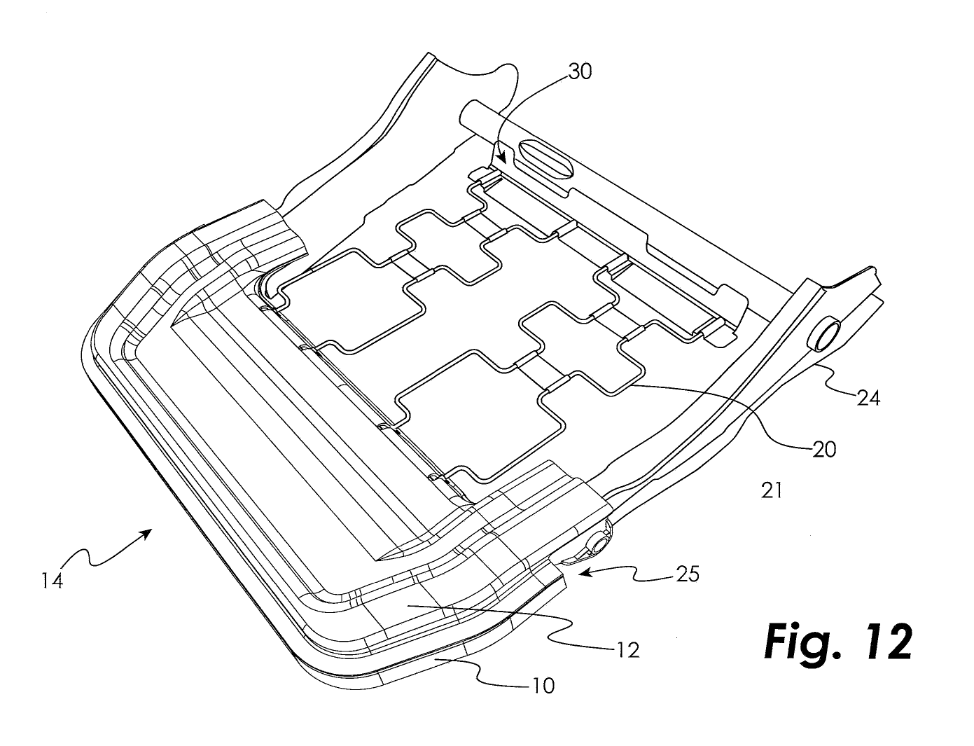

Preferably, from a top plan view as shown in FIGS. 3 and 5, the lower seat pan member 10 and upper seat pan member 12 each have a rectangular shape. Each opposite end of the lower seat pan member is configured and arranged to receive a proximal end 25 of a seat side support 24 (see FIGS. 11-12). Between the opposite ends, lower seat pan member 10 is configured and arranged to receive at least a portion of at least one seat pan support member,

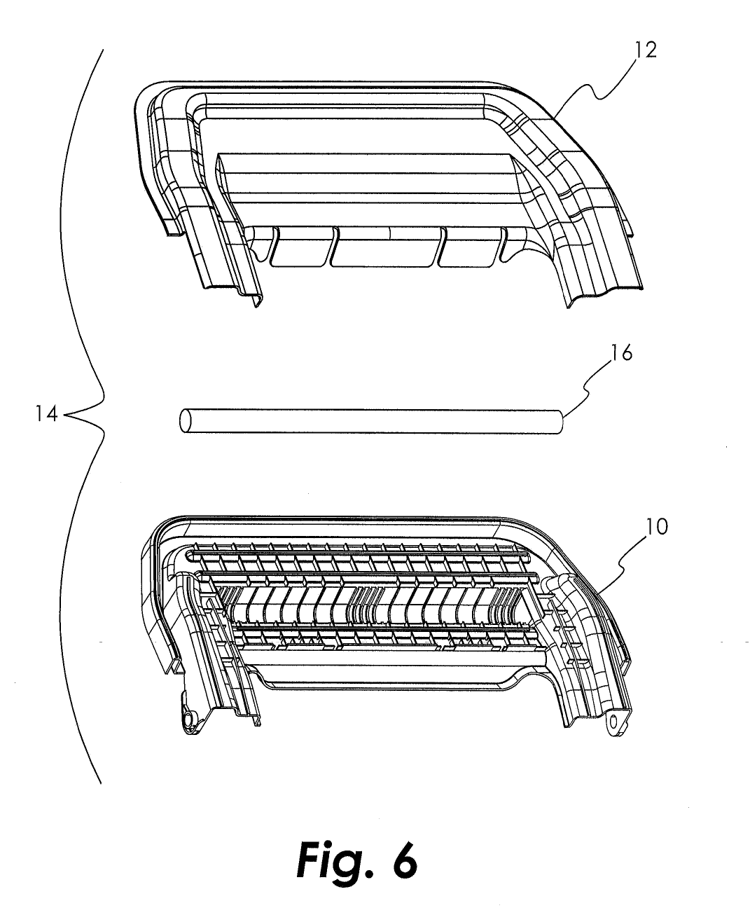

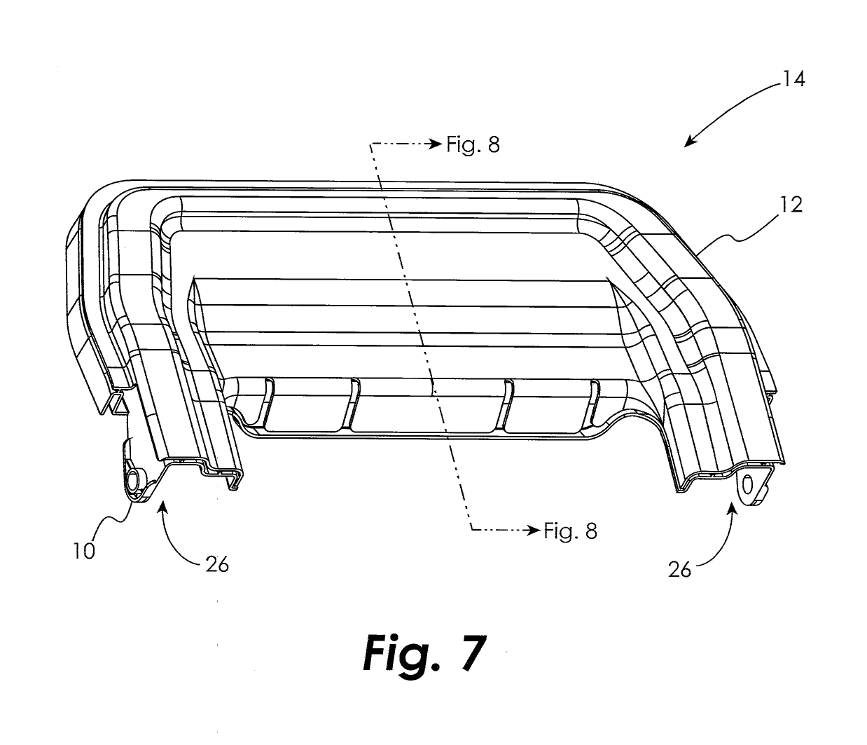

As shown in FIGS. 6-10, the lower seat pan member 10 may be joined to the upper seat pan member 12 in order to form seat pan assembly 14. Such joining may be made by any suitable means, such as by adhesive, sonic welding, vibration welding, laser welding or friction welding, to name just a few non-limiting examples. Once joined into the seat pan assembly 14, the members 10, 12 provide structural rigidity, form the desired contours of the seat pan upper, lower and side surfaces, provide spaces designed for the encapsulation of other parts, and provide attachment points for other portions of the seat. For example, a seat pan support member such as a front lift rod 16 may be positioned between the lower seat pan member 10 and the upper seat pan member 12 of seat pan assembly 14. Seat pan assembly 14 is one embodiment of seat pan 6 shown in FIG. 1.

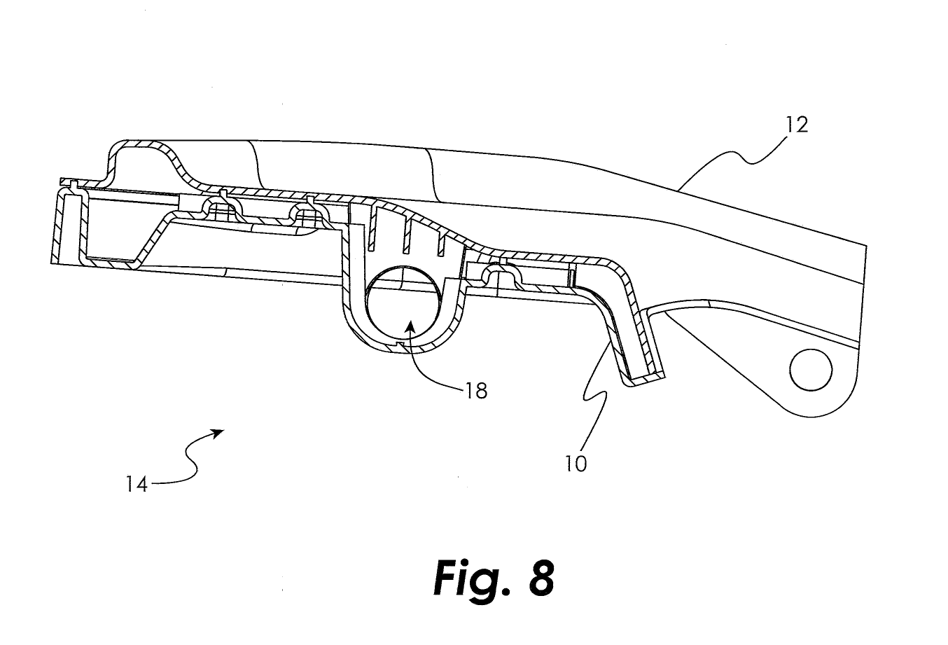

As shown in FIGS. 6 and 11, preferably at least one seat pan support member such as a front lift rod 16 is encapsulated within the seat pan assembly 14 during the process of joining the lower seat pan member 10 to the upper seat pan member 12. The front lift rod is preferably formed from metal but may also be formed from a hybrid of metal and plastic, and/or carbon fiber, to name just a few non-limiting examples. As can be seen in FIGS. 8-10, a space 18 is designed into the lower seat pan member 10 to receive the front lift rod 16 during assembly. Joining of the upper seat pan member 12 to the lower seat pan member 10 therefore permanently encapsulates the front lift rod 16 into the seat pan assembly 14.

As shown in FIGS. 11-12, the seat pan support member may also be a spring seat support such as a wire mesh seat support 20 that may have one end encapsulated between the lower seat pan member 10 and the upper seat pan member 12. It will be appreciated that the design of the seat support 20 is not critical to the present invention and a great variety of seat support designs can be used with the claimed invention. For example, the wire mesh seat support 20 may include one or more extensions 21 that extend between the lower seat pan member 10 and the upper seat pan member 12 such that one end of the wire mesh seat support 20 is encapsulated within the seat pan assembly 14 after joining. In some embodiments, the spring seat support such as the wire mesh seat support 20 is formed from a suitable metal material. In other embodiments, the spring seat support is formed from carbon fiber, textile, plastic, and/or plastic resin mesh. In some embodiments, the wire mesh seat support 20 is formed from the same plastic as one of the seat pan members 10, 12. In other embodiments, the wire mesh seat support 20 is formed from a different plastic using multi-injection molding, to name just one non-limiting example of an appropriate formation process.

In embodiments in which the lower seat pan member 10 and/or upper seat pan member 12 are formed prior to the insertion of the seat pan support member, the seat pan member 10 and 12 preferably define one or more slots or recesses to accommodate at least portions of the one or more seat pan support members. For example, the lower seat pan member 10 may define one or more slots or recesses 22 to accommodate the one or more extensions 21 of the wire mesh seat support 20. Similarly, the upper seat pan member 12 may define one or more slots or recesses 23 to accommodate the one or more extensions 21 of the wire mesh seat support 20. When the lower seat pan member 10 and the upper seat pan member 12 are joined and/or formed around the one or more extensions 21 of the wire mesh seat support 20, the extension(s) 21 pass through recesses 22 and 23 and are encapsulated between the upper and lower seat pan members 12 and 10.

Alternatively, the at least one seat pan support member may be encapsulated during the formation of the upper and/or lower seat pan members. If the seat pan assembly 14 is formed by a suitable process such as injection molding, thermoforming, injection compression molding, or blow molding, to name just a few non-limiting examples, at least a portion of the seat pan support member may be positioned inside a mold prior to the injection or molding of a plastic material around at least a portion of the seat pan support member. Advantageously, this may reduce the number of steps required to form the seat pan assembly 14 by combining the forming of the upper and lower seat pan members with the encapsulation of the at least one seat pan support member.

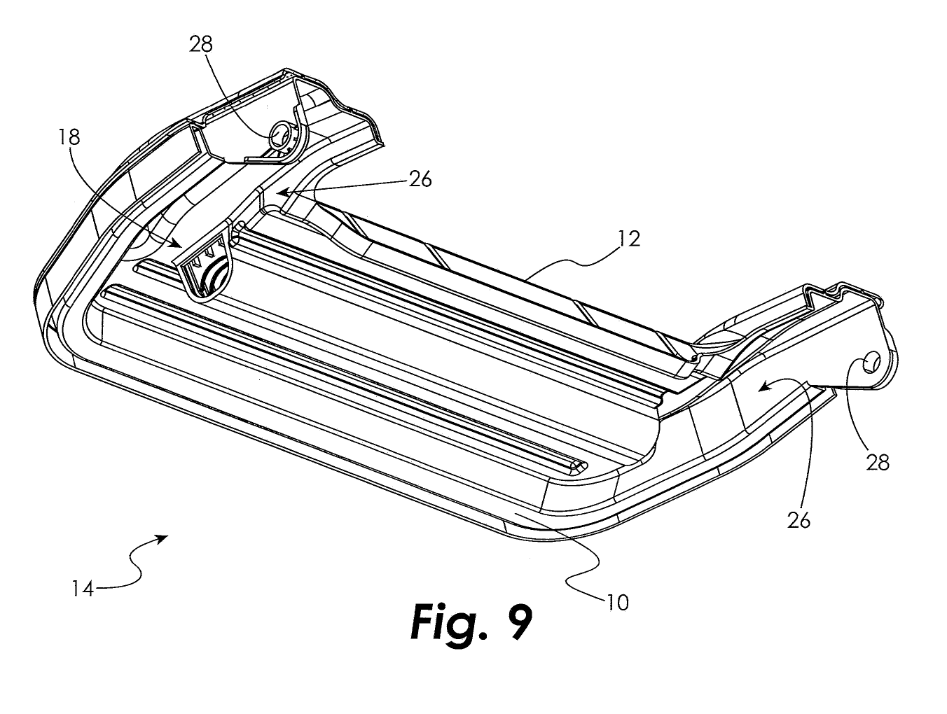

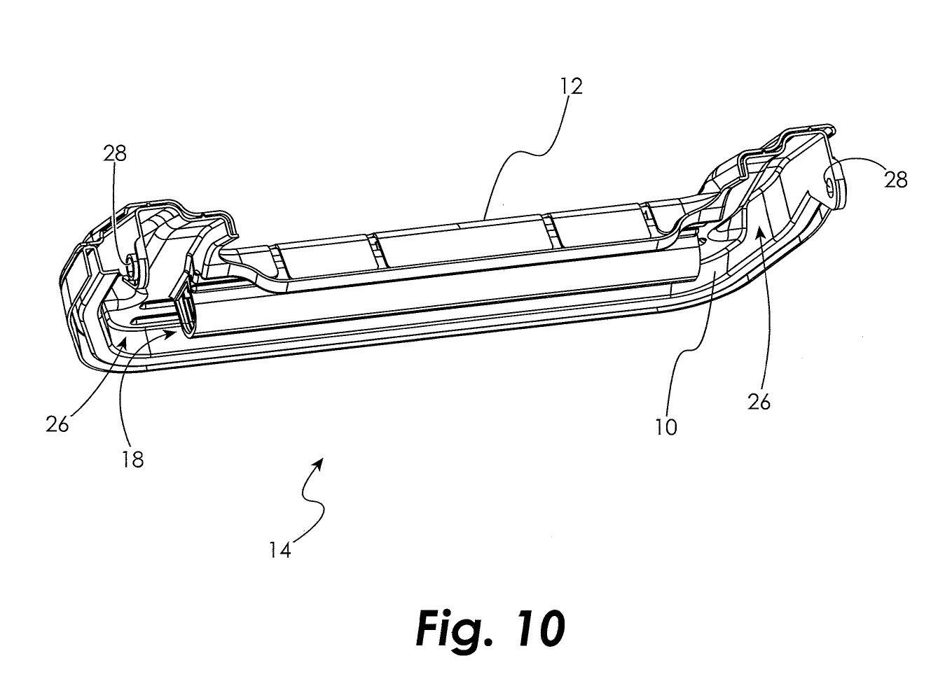

Once the seat pan assembly 14 is complete, it may be joined to a seat side support or seat riser 24. Proximal ends 25 of the seat side support 24 are inserted into recesses 26 of the seat pan assembly 14 (see FIGS. 9 and 10) and coupled to the front lift rod 16, through the open ends of space 18, for movement by an actuator motor (not shown).

The seat pan assembly 14 is further coupled to the seat side support 24 by means of bolts (not shown) that pass through the openings 28 in lower seat pan member 10 and corresponding openings (not shown) in the seat side support 24. These bolts increase the structural integrity of the seat pan assembly 14 and also aid in the installation of the seat pan by limiting any potential rotation of the upper and lower seat pan members 12 and 10 around the front lift rod 16 when the seat side supports 24 are coupled to the front lift rod 16. The end 30 of wire mesh seat support 20 opposite the end that is encapsulated in the seat pan assembly 14 is coupled to the seat side support 24 by any appropriate means, such as by means of the hooks 32, to name just one non-limiting example. The exact configuration of the seat side support 24 is not critical to the present invention.

It will be appreciated that forming the seat pan assembly 14 from plastic encapsulating the metal front lift rod 16 and one end of the wire mesh seat support 20 provides the required structural integrity and performance of the seat pan, while reducing weight and cost. The seat pan assembly therefore forms a subassembly that may easily be coupled to the remainder of the seat structure. Other seat components may also be encapsulated, such as rods, brackets and other supporting structure. Although one particular embodiment of a seat pan design has been illustrated, it will be appreciated that the principles of the present invention will find application in a wide variety of seating designs.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A seat for a motor vehicle, comprising:
a seat back;
a seat pan coupled to said seat back, said seat pan comprising an upper seat pan member and a lower seat pan member; and
a seat pan support member;
wherein said upper seat pan member and said lower seat pan member are configured and arranged to be joined together and encapsulate at least a potion of said seat pan support member positioned between said upper seat pan member and said lower seat pan member.

2. The seat of claim 1, wherein:
said seat pan support member is a front lift rod.

3. The seat of claim 2, wherein the material for said lift rod is selected from the group consisting of: metal, metal and plastic, and carbon fiber.

4. The seat of claim 1, wherein:
said seat pan support member is a spring seat support.

5. The seat of claim 4, wherein the material for said spring seat support is selected from the group consisting of: metal, carbon fiber, textile, plastic, and plastic resin mesh.

6. The seat of claim 1, wherein:
said lower seat pan member comprises more structural geometry than said upper seat pan member for providing rigidity to the assembly.

7. The seat of claim 1, wherein:
said upper seat pan member is comprised of a plastic material and said seat pan support member is comprised of metal.

8. The seat of claim 7, wherein said plastic material is selected from the group consisting of: polypropylene, polyethylene, polybutylene, and polyamide.

9. The seat of claim 1, further comprising:
a first recess being defined by said lower seat pan member and configured and arranged to receive said seat pan support member.

10. The seat of claim 1, wherein:
said upper seat pan member generally conforms to the contour of said lower seat pan member.

11. An assembly for a motor vehicle seat, comprising:
an upper seat pan member;
a lower seat pan member; and
a first seat pan support member encapsulated by said upper seat pan member and said lower seat pan member.

12. The assembly of claim 11, wherein:
said first seat pan support member is a front lift rod.

13. The assembly of claim 12, wherein the material for said lift rod is selected from the group consisting of: metal, metal and plastic, and carbon fiber.

14. The assembly of claim 11, wherein:
said lower seat pan member comprises more structural geometry than said upper seat pan member for providing rigidity to the assembly.

15. The assembly of claim 11, further comprising:
a first recess being defined by said lower seat pan member and configured and arranged to receive said first seat pan support member.

16. The assembly of claim 15, further comprising:
a second recess being defined by said lower seat pan member and configured and arranged to receive a second seat pan support member.

17. The assembly of claim 16, wherein:
said second seat pan support member is a spring seat support.

18. The assembly of claim 17, wherein the material for said spring seat support is selected from the group consisting of: metal, carbon fiber, textile, plastic, and plastic resin mesh.

19. The assembly of claim 11, wherein:
said upper seat pan member generally conforms to the contour of said lower seat pan member.

20. The assembly of claim 11, wherein:
said upper seat pan member is comprised of a plastic material and said first seat pan support member is comprised of metal.

21. The assembly of claim 20, wherein said plastic material is selected from the group consisting of: polypropylene, polyethylene, polybutylene, and polyamide.

22. A seat assembly, comprising:
an upper seat pan member;
a lower seat pan member;
a first seat pan support member; and
a second seat pan support member;
wherein said upper seat pan member and said lower seat pan member are configured and arranged to confine at least portions of said first seat pan support member and said second seat pan support member between said upper seat pan member and said lower seat pan member.

23. The assembly of claim 22, wherein:
said first seat pan support member is a front lift rod.

24. The assembly of claim 23, wherein the material for said lift rod is selected from the group consisting of: metal, metal and plastic, and carbon fiber.

25. The assembly of claim 22, wherein:
said lower seat pan member comprises more structural geometry than said upper seat pan member for providing rigidity to the assembly.

26. The assembly of claim 22, further comprising:
a first recess being defined by said lower seat pan member and configured and arranged to receive said first seat pan support member.

27. The assembly of claim 22, further comprising:
a second recess being defined by said lower seat pan member and configured and arranged to receive said second seat pan support member.

28. The assembly of claim 27, wherein:
said second seat pan support member is a spring seat support.

29. The assembly of claim 28, wherein the material for said spring seat support is selected from the group consisting of: metal, carbon fiber, textile, plastic, and plastic resin mesh.

30. The assembly of claim 22, wherein:
said upper seat pan member generally conforms to the contour of said lower seat pan member.

31. The assembly of claim 22, wherein:
said upper seat pan member is comprised of a plastic material and said first seat pan support member is comprised of metal.

32. The assembly of claim 31, wherein said plastic material is selected from the group consisting of: polypropylene, polyethylene, polybutylene, and polyamide.

33. A method of assembling a seat pan, comprising:
positioning a first seat pan support member between an upper seat pan member and a lower seat pan member; and
joining the upper seat pan member to the lower seat pan member so as to encapsulate the first seat pan support member and assemble the seat pan.

34. The method of claim 33, wherein:
positioning a first seat pan support member comprises positioning a first seat pan support member in at least one recess in the lower seat pan member.

35. The method of claim 33, further comprising:
positioning a second seat pan support member between said upper seat pan member and said lower seat pan member.

36. The method of claim 35, wherein:
positioning a first seat pan support member comprises positioning a first seat pan support member in at least one recess in the lower seat pan member; and
positioning a second seat pan support member comprises positioning a second seat pan support member in at least one recess in the lower seat pan member.

37. The method of claim 36, wherein:
one of said recesses for said first seat pan support member is separate from at least one of said recesses for said second seat pan support member.

38. The method of claim 33, wherein:
positioning a first seat pan support member comprises positioning a first seat pan support member comprised of metal, between an upper seat pan member comprised of a plastic material and a lower seat pan member comprised of a plastic material.

39. The method of claim 33, wherein:
joining the upper seat pan member to the lower seat pan member is selected from the group consisting of: adhesive, sonic welding, vibration welding, laser welding, and friction welding.

40. A method of forming a seat pan, comprising:
positioning at least a portion of at least one seat pan support member in a mold;
molding a plastic material around the seat pan support member to encapsulate at least a portion of the seat pan support within said plastic material so as to form a seat pan.

41. The method of claim 40, wherein molding a plastic material comprises molding a plastic material selected from the group consisting of: polypropylene, polyethylene, polybutylene, and polyamide.

42. The method of claim 40, wherein:
positioning at least one seat pan support member in a mold comprises positioning a lift rod inside the mold.

43. The method of claim 42, wherein positioning a lift rod comprises positioning a lift rod selected from the group consisting of: metal, metal and plastic, and carbon fiber.

44. The method of claim 40, wherein:
positioning at least one seat pan support member in a mold comprises positioning a spring seat support inside the mold.

45. The assembly of claim 44, wherein positioning a spring seat support comprises positioning a spring seat support selected from the group consisting of: metal, carbon fiber, textile, plastic, and plastic resin mesh.

46. The method of claim 40, wherein:
molding a plastic material around the seat pan support member is selected from the group consisting of: injection molding, thermoforming, injection compression molding, and blow molding.
